(19) United States
(12) Patent Application Publication
(10) Pub. No.: US 2026/0329733 A1
(43) Pub. Date: Oct. 22, 2026

(54) AUTOMATED SOFTWARE PATCH GENERATION

(71) Applicant: NVIDIA Corporation, Santa Clara, CA (US)

(72) Inventor: Maksym Bazalii, Timnath, CO (US)

(21) Appl. No.: 19/184,367

(22) Filed: Apr. 21, 2025

(51) Int. Cl. G06F 11/3668; G06F 8/35; G06F 8/41

(52) U.S. Cl. CPC G06F 11/3688; G06F 8/35; G06F 8/41

(57) ABSTRACT

Embodiments of the present disclosure relate to applications, platforms, architecture, etc. for automatically generating reliable fixes or patches for reproducible defects in source code. In particular, one or more artificial intelligence (AI) models are used to process a prompt based at least in part on the source code, a defect, and contextual information for the defect to generate a corrected version of the source code. Further, the applications, platforms, architecture, etc. may determine whether the corrected version of the source code resolves the defect and apply the changes implemented in the corrected version of the source code to the source code.

### BACKGROUND

Modern software development uses automated testing techniques like unit tests, integration tests, static analysis, and fuzzing to identify defects in software systems. While these methods effectively detect potential issues, analyzing and fixing them still require significant manual effort from experienced software engineers. This process often becomes tedious and time-consuming.

Recently, Large Language Models (LLMs) have emerged as potential tools for code analysis and defect remediation. These models, trained on large code repositories, can analyze code segments and suggest fixes. However, current LLM-based solutions have limitations. For example, a main limitation is their narrow operational scope, as these LLM-based solutions work at the function level without access to the broader program context, which includes dependencies, data types, and execution flows. This limited perspective results in incomplete or incorrect remediation proposals. Additionally, there are no automated verification mechanisms for the generated patches, making manual validation by engineers essential.

### BRIEF DESCRIPTION OF THE DRAWINGS

The present systems and methods for automated software patch generation are described in detail below with reference to the attached drawing figures, wherein:

FIG. 1 is a schematic block diagram of a software lifecycle management, in accordance with one or more aspects of the present disclosure;

FIG. 2 is an example diagram of the defect patch module 135 of FIG. 1 for automatic patch generation, in accordance with one or more aspects of the present disclosure;

FIG. 3 is an example diagram of the defect detection component of FIG. 2, in accordance with one or more aspects of the present disclosure;

FIG. 4 is an example diagram of the defect analysis component of FIG. 2, in accordance with one or more aspects of the present disclosure;

FIG. 5 is an example diagram of the patch recommendation component of FIG. 2, in accordance with one or more aspects of the present disclosure;

FIG. 6 is an example diagram of the patch application component of FIG. 2, in accordance with one or more aspects of the present disclosure;

FIG. 7 is an example diagram of the patch validation component of FIG. 2, in accordance with one or more aspects of the present disclosure;

FIG. 8 is an example diagram of the patch approval component of FIG. 2, in accordance with one or more aspects of the present disclosure;

FIG. 9 is a flow diagram for automatic patch generation is a block diagram of an example generative language model system, in accordance with one or more aspects of the present disclosure;

FIG. 10A is a block diagram of an example generative language model system, in accordance with one or more aspects of the present disclosure;

FIG. 10B is a block diagram of an example generative language model that includes a transformer encoder-decoder, in accordance with one or more aspects of the present disclosure;

FIG. 10C is a block diagram of an example generative language model that includes a decoder-only transformer architecture, in accordance with one or more aspects of the present disclosure;

FIG. 11 is a block diagram of an example computing device, in accordance with one or more aspects of the present disclosure; and

FIG. 12 is a block diagram of an example data center, in accordance with one or more aspects of the present disclosure.

### DETAILED DESCRIPTION

Embodiments described herein relate to systems and methods for automatically generating reliable fixes or patches for reproducible defects in source code. In particular, the system identifies defects, such as crashes, hangs, or anomalous behavior, through test suite execution. The system generates detailed contextual information about the defects, including identifiers, file paths, function names, line numbers, defect types, stack traces, and log excerpts. Using AI models, the system processes this contextual information to generate corrected versions of the source code. These corrections are validated by compiling and executing test cases on the corrected code. If no defects are detected, the changes are committed and integrated into the primary code branch. If conflicts arise during integration, predefined reconciliation rules or manual intervention resolve them.

In some embodiments, source code is analyzed for software defects. The source code may be copied and compiled into a binary. The binary may then be tested by executing one or more test cases of a test suite. Each test case of the test suite includes one or more test inputs which can be inputted via an input handling mechanisms, such as command-line arguments, standard input, file-based input, network protocols, API calls, and environment variables. Each of the test inputs may be, for example, a mutated version of a valid input to explore an edge case, a strategically generated input that probes a potential vulnerability, and an input systematically derived from s known format specification or s protocol definition. During testing, execution may be monitored to track code coverage, memory usage, and runtime behavior using diagnostic tools (e.g., sanitizers) to provide detailed information of a defect and/or source code analysis tools (e.g., libclang), to generate code contexts. The sanitizers can include an address sanitizer, a memory sanitizer, a thread sanitizer, an undefined behavior sanitizer, a leak sanitizer, a type sanitizer, and/or a real-time sanitizer. Address sanitizer detects memory corruption issues. A memory sanitizer detects access violations to the uninitialized memory. Thread analyzers identify synchronization issues like race conditions and deadlocks. An undefined behavior sanitizer detects undefined behavior patterns during code execution. A leak sanitizer identifies heap memory leaks at runtime. A type sanitizer detects type aliasing violations at runtime. A real-time sanitizer detects real-time requirement violations, such as unsafe calls from the function with deterministic run time requirements. Code context can include call graphs, function dependencies, and data types, to provide deeper insights into a portion of the binary that experiences the defect.

Defects refer to instances where the binary crashes, hangs, or exhibits other anomalous behavior. Each defect detected during execution of a test case may be recorded as a test log. The test log includes contextual information of a respective detected defect. Contextual information of the respective detected defect includes, for example, a diagnostic tool identifier, a test case identifier, a file path, a function name, a line number, a defect type, a stack trace, structural data, log excerpts, reproduction scenarios, or diagnostic data. In some embodiments, the test log for the respective detected defect can also include a trace log. A trace log is a detailed record of a program's execution that captures function calls, system events, and variable states, helping developers debug issues, monitor performance, and analyze system behavior.

Each test log may be analyzed to generate a defect analysis log which may be included in a defect analysis report. The defect analysis log provides a detailed analysis of one or more respective detected defects in a respective test log and includes, for example, source code associated with the respective detected defect, a synopsis the respective detected defect, a probable root cause for the respective detected defect, historical context for the respective detected defect, and/or related recurring bug associated with the respective detected defect.

In embodiments, the processing logic generates an input request (e.g., a prompt) based on the defect analysis log for an artificial intelligence (AI) model such as an LLM to process the respective detected defect and provide corrections. In some embodiments, the input request may include a resolution strategy to assist the AI model in processing the respective detected defect of the defect analysis log. The input request may be submitted to the AI model. The AI model may output source code modifications. In embodiments, the source code modifications may be represented as a code diff, which shows the difference between the source code and a corrected version of the source code. The code diff may highlight additions, deletions, and/or modifications between the source code and the corrected version of the source code.

The corrected version of the source code may be analyzed for proper issue resolution, code quality, implementation correctness, and/or bug prevention (e.g., verification of the corrected source code). In some embodiments, the AI model, in an agent-as-judge role, analyzes the corrected version of the source code and validates it against a predefined checklist to ensure proper integration, test coverage, and/or complete implementation (e.g., avoiding commented-out code). In some embodiments, an additional AI model (e.g., an additional LLM acting in the capacity of LLM-as-judge), performs validation and additional verification steps, separate from the AI model that generated the corrected version of the source code. The additional AI model may check integration, test coverage, and/or implementation completeness while also conducting quality assessment of approaches, ranking multiple solutions, and/or verifying compliance against standardized criteria beyond a predefined checklist. If verification of the corrected version of the source code is unsuccessful, the corrected version of the source code may be provided to the AI model with feedback regarding the verification results (e.g., incomplete test coverage, remaining defects, etc.) to further refine the corrected version of the source code.

Once verification of the corrected version of the source code is successful, a code diff may be applied to a copy of the source code by analyzing the specified changes in the code diff. In embodiments, lines marked for addition are inserted, lines marked for removal are deleted, and/or modified lines are replaced with their updated versions. As a result, an updated version of the source code may be generated that reflects the intended changes.

The updated version of the source code may be compiled into an updated binary. The updated binary may be tested by re-executing the one or more test cases of the test suite. If a new defect is detected in a respective test case, processing logic may determine whether the new detected defect matches the respective detected defect. If the new detected defect matches the respective detected defect, the processing logic may update the test log for the respective detected defect to include additional contextual information for the new detected defect. If the new detected defect does not match the respective detected defect, the processing logic may generate a new test log with the contextual information of the new detected defect (and its corresponding trace log). In embodiments, the processing logic updates the defect analysis log for the respective detected defect and/or generates a new defect analysis log for the new detected defect. The processing logic may further refine the updated version of the source code (e.g., the code diff used to generate the updated version of the source code) based on the updated defect analysis log (or the new defect analysis log). Once the respective detected defect (or the new defect analysis log) is resolved, the code diff may be presented for approval as a proposed solution for correcting or patching the source code. In response to receiving approval of the code diff, processing logic may apply the code diff to the source code to correct the source code. In some embodiments, rather than receiving approval of the code diff, the processing logic may automatically review and apply the code diff to correct the source code. Accordingly, code may be corrected without any user input in embodiments (e.g., with the entire process of defect detection, isolation, patching, and review being automated).

In some embodiments, the systems and methods described herein may be performed within a simulation environment (e.g., NVIDIA's DriveSIM, NVIDIA's ISAAC GYM, NVIDIA's ISAAC SIM, etc.) using simulated data (e.g., simulated sensor data of simulated sensors of a virtual or simulated machine). For example, simulated sensor data may be used (e.g., processed using one or more machine learning models, neural networks, etc.) to identify, detect, and/or classify lane lines, road boundary lines, other lines, vertical structures/features, etc. within the simulation environment using points of a curve and/or one or more curve fitting algorithms, and may use this information to perform operations (e.g., control, navigation, planning, etc. operations) associated with the virtual machine within the environment. These simulated operations may be used to test performance of the underlying algorithms, systems, and/or processes prior to deploying them in the real-world. In some instances, the simulation may be used to generate synthetic training data—e.g., training data including regions of interest and/or sub-regions of interest from within the simulation. In some embodiments, other methods may be used in addition or alternatively from a simulation to generate synthetic training data. For example, the synthetic training data may be generated using neural rendering fields (NERFs), Gaussian splat techniques, diffusion models, electrostatic models (e.g., Poisson flow generative models (PFGMs), etc. The synthetic training data (in addition to or alternatively from real-world data) may then be processed to determine geometry, curvature, semantic information, classification information, and/or other information related to features of interest, such as lines, longitudinal features (e.g., poles), and/or other features within a driving environment, a warehouse, etc., for example. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system that uses universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

In some embodiments, teleoperation or remote control of a vehicle or other machine may be performed using a remote control or teleoperation system. For example, the systems and methods described herein may be used to identify lane lines, road boundary lines, longitudinal features, etc. that may be included in a visualization or mapping of an environment to aid a remote operator in controlling—or providing waypoints or other indications of control or navigation—an autonomous or semi-autonomous machine through an environment.

In some examples, the machine learning model(s) (e.g., deep neural networks, language models, LLMs, VLMs, multi-modal language models, vision-language-action (VLA) models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, VLM, MMLM, diffusion model, transformer model, NeRF, DNN, etc.) and/or the image database hosted on the local and/or remote servers using one or more APIs—such as, without limitation, REST APIs.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models, vision language models (VLMs), large language models (LLMs), vision-language-action (VLA) models, multi-modal language models (MMLMs), etc.) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, VLAs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), vision-language-action (VLA) models, etc.), and/or other types of machine learning models.

In some embodiments, one or more transformer engines (TEs) may be implemented. The transformer engine may use micro-tensor scaling to optimize performance and accuracy-such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using switches—such as NVLink Switches) and tensor cores (which enable mixed-precision computing, such as microscaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

Advantages of the present disclosure include, but are not limited to, automatic detection of defects, and automatic generation of reliable software patches for detected defects, significantly reducing the time and effort required to correct errors in software and/or firmware compared to manual remediation processes. Additionally, embodiments facilitate seamless integration and testing of code modifications with minimal manual intervention, thereby enhancing efficiency and ensuring higher accuracy in resolving software issues.

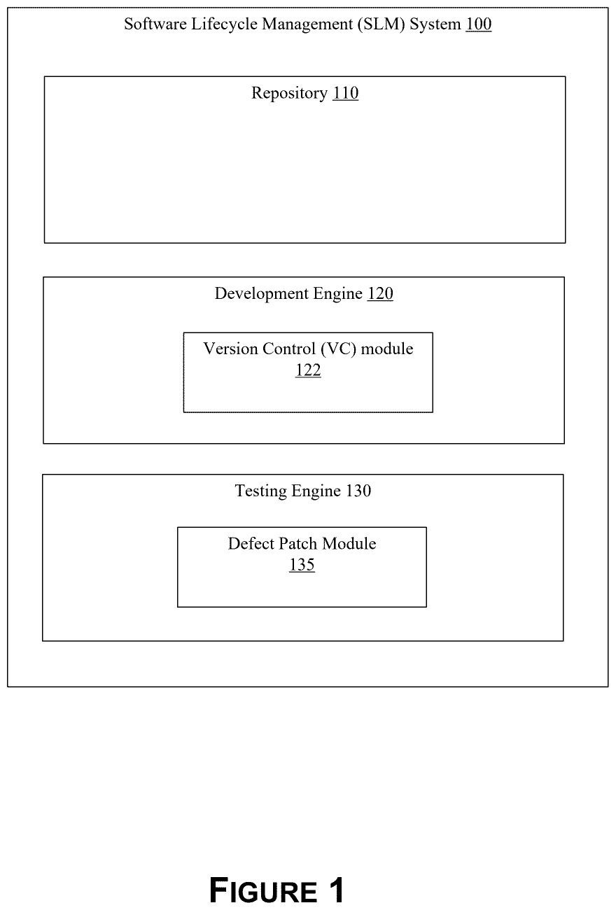

FIG. 1 illustrates a schematic block diagram of a software lifecycle management (SLM) system 100 in which automatic patch generation is performed, in accordance with one or more aspects of the present disclosure. The SLM system 100 manages the iterative process of software development where developers create, test, and refine computer-readable instructions, known as source code, to implement functionality. The SLM system 100 comprises, among other components, a repository 110, a development engine 120, and a testing engine 130.

The repository 110 implements a storage structure to organize and track software development artifacts (“artifacts”), with source code files being the primary artifacts for development operations. In some embodiments, the storage structure is hierarchical, organizing artifacts into directories and subdirectories. The repository 110 tracks individual artifacts, maintaining associated metadata which may include file paths, permissions, timestamps, and authorship information. The artifacts include source code files and may also include supporting elements such as configuration files, build scripts, documentation, and other elements necessary for project development.

The repository 110 employs version tracking structures to maintain relationships between different versions of the artifacts, particularly versions of source code files. In some embodiments, the version tracking structure is implemented through a directed acyclic graph (DAG), where nodes in the DAG represent specific versions and edges in the DAG represent relationships between the versions. The version tracking structure stores version states, maintains version history, and implements state management mechanisms for modifying the version data. These mechanisms ensure data consistency during concurrent access and modifications to the version tracking structure.

The development engine 120 manages software development operations (“development operations”) by coordinating version control and development workflows. The development engine 120 performs read and write operations on the storage structure and version tracking structure of the repository 110. In some embodiments, the development engine 120 includes a version control (“VC”) module 122 that executes fundamental version control operations. These VC module 122 operations include, but are not limited to, creating versions of artifacts (“commits”), tracking changes between commits, and maintaining relationships between different versions of artifacts. The VC module 122 retrieves version states from the version tracking structure of the repository 110 and updates version states when creating commits or modifying version relationships. The VC module 122 implements operations for branch creation, tracks the state of each branch, and maintains relationships between branches. In some embodiments, the VC module 122 designates certain branches as primary branch, which maintain stable versions of the artifacts. When changes from other branches are integrated, the VC module 122 implements conflict detection and resolution mechanisms to maintain code integrity.

The testing engine 130 coordinates with the development engine 120 to validate changes to the artifacts before integration into primary branch. The testing engine 130 executes test suites, analyzes test results, and provides validation status to the development engine 120. In some embodiments, the development engine 120 uses this validation status to determine whether changes can be merged between branches.

In some embodiments, the testing engine 130 includes a defect patch module 135. The defect patch module 135 may be implemented using processor(s) and optionally one or more other components or engines (e.g., the development engine 120).

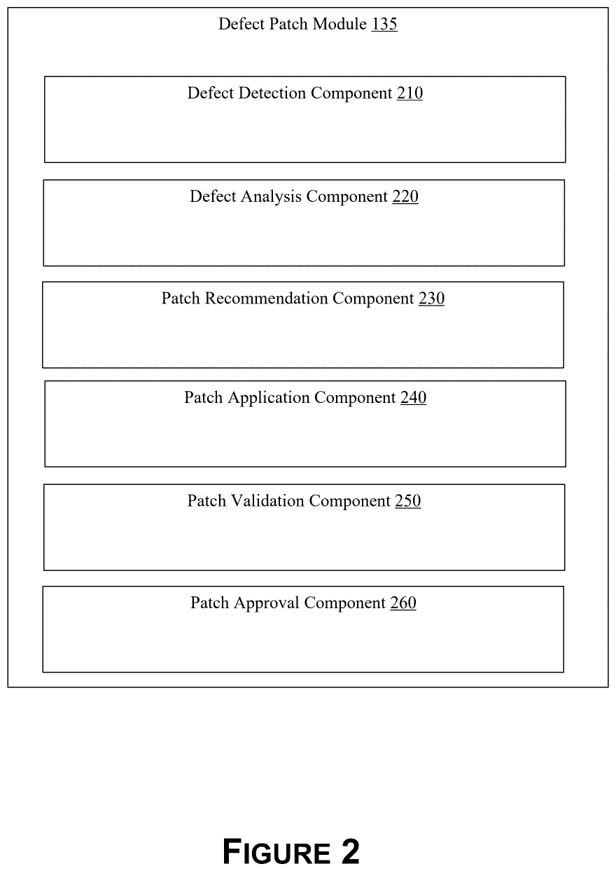

FIG. 2 is an example diagram of the defect patch module 135 of FIG. 1 for automatic patch generation, in accordance with one or more aspects of the present disclosure. The defect patch module 135 includes a defect detection component 210, a defect analysis component 220, a patch recommendation component 230, a patch application component 240, a patch validation component 250, and a patch approval component 260 in some embodiments. It should be understood that the operations of one or more of the defect detection component 210, defect analysis component 220, patch recommendation component 230, patch application component 240, patch validation component 250, and/or patch approval component 260 may be combined into a single component. Additionally, or alternatively, the operations of one or more of the defect detection component 210, defect analysis component 220, patch recommendation component 230, patch application component 240, patch validation component 250, and/or patch approval component 260 may be split into multiple components.

In embodiments, the defect patch module 135 is initiated in response to commit operations in the VC module 122, such as when changes to source code files are proposed for integration into the primary branch. The component may also be initiated at predetermined intervals as part of continuous integration and continuous delivery (CI/CD) processes, or through manual triggers during the development process. CI/CD processes automate the building, testing, and deployment of changes to source code files and related artifacts to ensure consistent validation and delivery.

Once the defect patch module 135 is triggered, the defect detection component 210 initiates testing on a source code to validate syntax, functionality, interactions, and/or performance. The defect detection component 210 may execute a test suite on the source code to identify defects, and provides a test report. The test report serves as a detailed record of the test suite and its outcomes, including information about detected defects. The test report may provide valuable insights into the behavior and quality of the source code being tested. The defect detection component 210 provides the test report, along with execution related information for the test suite (e.g., trace logs), to the defect analysis component 220 in embodiments.

The defect analysis component 220 analyzes the test report and the execution related information to generate a defect analysis report. The defect analysis report serves as a comprehensive document that details the analysis of detected defects in the test report, including their identification, root causes, and historical patterns. The defect analysis component 220 provides the defect analysis report to the patch recommendation component 230.

The patch recommendation component 230, uses one or more artificial intelligence (AI) model, such as a Large Language Model (LLM) based code generator, or a rules-based engine, to generate source code modifications (optionally represented as code diffs) to address each detected defect identified by the defect detection component 210. The patch recommendation component 230 may further validate the code diffs to ensure adherence to coding guidelines, to ensure that code diffs are properly integrated, and/or to include comprehensive test coverage. The patch recommendation component 230 may further refine one or more code diffs until they are validated. The patch recommendation component 230 provides the code diffs to the patch application component 240 in embodiments.

The patch application component 240 may create a new branch (e.g., a fix branch) in the version control component (VC module) 122 to allow independent modifications from a primary branch. The patch application component 240 may apply the code diffs and create a commit with a descriptive message. In embodiments, the patch application component 240 pushes the changes to the repository 110, generating a pull request for formal integration of the source code modifications from the fix branch into the primary branch.

In embodiments, the patch validation component 250 initiates testing on the fix branch (e.g., a modified source code from the fix branch generated by the source code modifications) in response to the generation of the pull request. The patch validation component 250, similar to the defect detection component 210, executes the test suite on the modified source code to identify defects. The patch validation component 250 may modify the test report to reflect resolution of previously detected defects, reoccurrence of previously detected defects, and/or introduction of new defects. If the test report indicates that previously detected defects are resolved and there are no new defects, the patch validation component 250 notifies the patch approval component 260 that the modified source code from the fix branch has been validated. Otherwise, the patch approval component 260 may provide the modified test report to the defect analysis component 220 to repeat the process. In other words, performing operations of the defect analysis component 220, the patch recommendation component 230, the patch application component 240, and the patch validation component 250 may repeat operations until the modified source code from the fix branch is validated.

In embodiments, the patch approval component 260 notifies, in response to receiving notification that the modified source code from the fix branch has been validated, a designated reviewer that the pull request for formal integration of the source code modifications from the fix branch into the primary branch is ready. The patch approval component 260 may receive an input from the designated reviewer. The input from the designated reviewer may indicate approval, rejection, or a request additional modification to the source code modifications from the fix branch. The patch approval component 260 may cause the development engine 120 to merge the source code modifications from the fix branch into the primary branch. In some embodiments, the patch approval component 260 may automatically, without a designated reviewer, make a determination whether to approve, reject, or request additional modification. Thus, the patch approval component 260 using the automated determination may cause the development engine 120 to merge the source code modifications from the fix branch into the primary branch without first receiving user input.

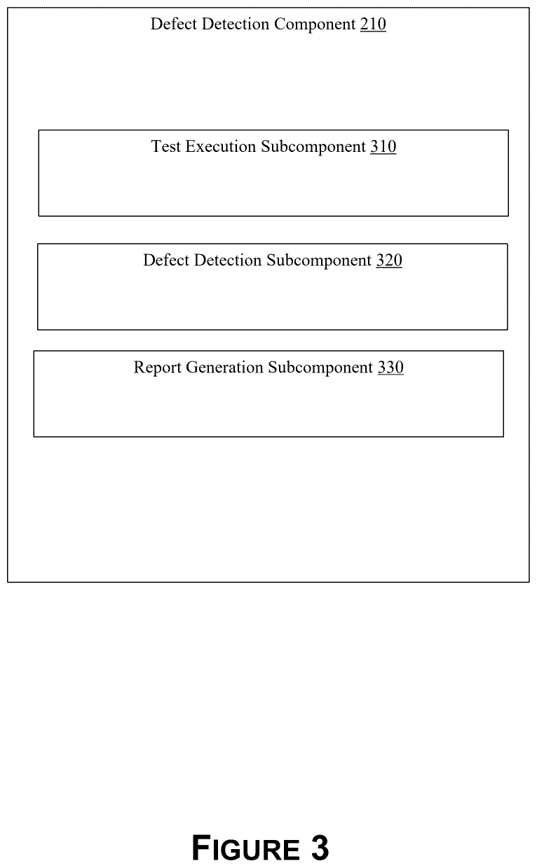

FIG. 3 is an example diagram of the defect detection component 210 of FIG. 2, in accordance with one or more aspects of the present disclosure. In one embodiment, the defect detection component 210 includes a test execution subcomponent 310, a defect detection subcomponent 320, and a report generation subcomponent 330.

The test execution subcomponent 310 provides a structured environment where the test suite is executed, monitored, and evaluated. This environment supports various types of tests or testing strategies. Unit tests examine individual components in isolation. Integration tests verify components work together correctly. Functional tests check if the system meets user requirements. System tests evaluate the entire system's behavior. Performance tests measure how the system handles different loads. Security tests identify vulnerabilities. Regression tests ensure new changes don't break existing features. Static analysis tests check code without running it. Fuzzing tests use random inputs to find unexpected behaviors. The test suite, such as a fuzzing test suite, comprises multiple test cases, where each test case includes one or more test inputs. The test inputs can include mutated versions of valid inputs to software under test to explore edge cases, strategically generated inputs probing potential vulnerabilities, and/or inputs derived from format specifications and/or protocol definitions. The test execution subcomponent 310 manages system resources, establishes test environments, injects test inputs, and/or captures execution outputs in embodiments. The test execution subcomponent 310 enables diagnostic tools, such as sanitizers, to provide detailed information of a defect. Additionally, or alternatively, the test execution subcomponent 310 enables source code analysis tools, such as libclang, to generate code contexts. The sanitizers can include an address sanitizer, a memory sanitizer, a thread sanitizer, an undefined behavior sanitizer, a leak sanitizer, a type sanitizer and/or a real-time sanitizer. An address sanitizer detects memory corruption issues. A memory sanitizer detects access violations to the uninitialized memory. A thread analyzer identifies synchronization issues like race conditions and deadlocks. An undefined behavior sanitizer detects undefined behavior patterns during code execution. A leak sanitizer identifies heap memory leaks at runtime. A type sanitizer detects type aliasing violations at runtime. A real-time sanitizer detects real-time requirement violations, such as unsafe calls from the functions with deterministic run time requirements. Code context can include call graphs, function dependencies, and/or data types, to provide deeper insights into a portion of the software (e.g., binary) that experiences the defect. In embodiments, the test execution subcomponent 310 executes the test suite comprising a plurality of test cases designed to validate functionality and identify defects.

In embodiments, the test execution subcomponent 310 creates a copy of the source code and compiles it into a binary with appropriate instrumentation for code coverage tracking, memory usage monitoring, and/or runtime behavior observation. The test execution subcomponent 310 may provide test inputs through various input handling mechanisms including command-line arguments, standard input, file-based input, network protocols, API calls, and environment variables.

In embodiments, for each test case, during test execution of the test suite, the defect detection subcomponent 320 evaluates execution results, diagnostic tools outputs, and system responses to identify defects in a respective test case. Defects may manifest as abnormal return codes, diagnostic tool findings, failed assertions, error outputs, crashes, timeouts, and/or exceptions. In some embodiments, a corresponding trace log may be generated for each test case. A trace log is a detailed record of a program's execution that captures function calls, system events, and variable states, helping developers debug issues, monitor performance, and analyze system behavior.

For each defect detected in the respective test case, the defect detection subcomponent 320 may provide contextual information about the detected defect to the report generation subcomponent 330. The contextual information can include a diagnostic tool identifier, a test case identifier, a file path, a function name, a line number, a defect type, a stack trace, structural data, log excerpts, reproduction scenarios, diagnostic data, and so on. The diagnostic tool identifier may indicate the diagnostic tool that detected the defect. The test case identifier may indicate which respective test case uncovered the defect. The function name may indicate which function contained the defect. The file path may indicate which source code file contained the defect. The line number may indicate which line in the source code contained the defect. The defect type may indicate what kind of defect occurred, such as heap-use-after-free or data race. The stack trace may indicate which sequence of function calls led to the defect. The structural data (generated by the source code analysis tool) may include call graphs showing function relationships, dependencies between files and types, and/or data type definitions with their relationships and layouts. The log excerpts capture relevant portions of test execution, analyzer output, system, application, debug, and/or error logs generated during execution, providing additional debugging context. The reproduction scenarios may indicate which inputs and conditions caused the defect to occur. The diagnostic data may indicate which memory states, performance metrics, and environment conditions existed when the defect occurred.

The report generation subcomponent 330 creates, in response to a first execution of a test suite on the source code, a test report. During creation of the test report, the report generation subcomponent 330 includes the test suite metadata at the beginning of the test report. The test suite metadata may include information about the test suite, such as a change reference identifier, a test suite identifier, a timestamp, and/or environment information. The change reference identifier may indicate which commit, pull request, and/or build initiated the testing. The test suite identifier may uniquely identify the specific test suite. The timestamp indicates when the test suite was initiated. Environment information may include details about compiler flags, operating system, and/or other system configurations. The test report may be generated in either raw text or JSON format.

As the report generation subcomponent 330 is receiving contextual information for each detected defect, the report generation subcomponent 330 includes or generates a test log which may be added to the test report, including the received contextual information (and its corresponding trace log).

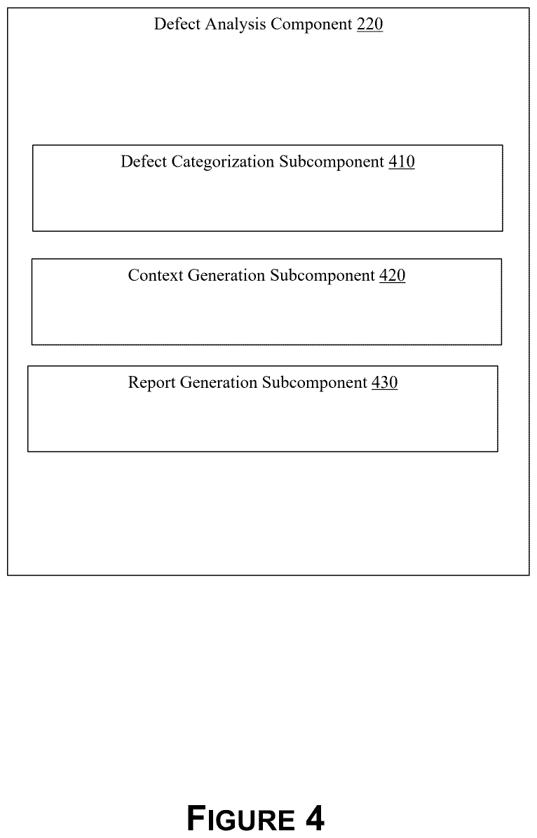

FIG. 4 is an example diagram of the defect analysis component 220 of FIG. 2, in accordance with one or more aspects of the present disclosure. In one embodiment, the defect analysis component 220 includes a defect categorization subcomponent 410, a context generation subcomponent 420, and a report generation subcomponent 430.

For each test log in the test report, the defect categorization subcomponent 410 may identify a root cause of a defect associated with a respective test log. In embodiments, the defect categorization subcomponent 410 generates a synopsis of the respective test log based on the contextual information of the defect associated with the respective test log. The synopsis may include the diagnostic tool identifier, the defect type, the file path, and/or the line number from the contextual information of the defect associated with the respective test log. For example, the synopsis might use a template like “The [diagnostic tool identifier] reported [defect type] in [file path] at [line number].” In embodiments, the defect categorization subcomponent 410 identifies a probable root cause category for the respective test log in view of the defect type. The probable root cause category can include, for example, memory mismanagement, concurrency, logic error, undefined behavior, special case, and/or other defect types. The memory mismanagement category may include, for example, heap use after free, buffer overflow, invalid memory access, and/or other memory-related errors. The concurrency category may include synchronization defects such as data races, deadlocks, and/or race conditions. The logic error category may include programming mistakes such as off-by-one errors, null pointer dereferences, and/or incorrect calculations. The undefined behavior category includes operations not defined by the programming language specification. The special case category includes edge cases and boundary conditions that trigger defects.

In embodiments, the context generation subcomponent 420 fetches, from the repository 110, historical versions of the source code that resulted from commits, merges, and/or fixes to functions similar to a function of the source code identified by the function name from the contextual information of the defect associated with the respective test log. The context generation subcomponent 420 may extract those functions in the historical versions of the source code as the historical context for the respective test log. The context generation subcomponent 420 may fetch, using the file path from the contextual information of the defect associated with the respective test log, a source code file. In some embodiments, the context generation subcomponent 420 maintains a record of recurring bugs and corresponding defect. Recurring bugs are defects that manifest in similar ways across different portions of source code, characterized by common defect types, execution patterns, and/or coding practices that lead to defects. For example, recurrent bugs and/or defects may include common concurrency mistakes, known memory usage patterns that often cause leaks, and/or frequently encountered off-by-one scenarios. Accordingly, the context generation subcomponent 420 may identify a related recurring bug for the respective test log by referencing the record of recurring bugs to determine whether the defect associated with the respective test log matches a recurring bug of the record of the recurring bugs. In other words, the record of recurring bugs may provide additional insight into whether a historical pattern of issues indicates a presence of a similar issue.

In embodiments, the context generation subcomponent 420 provides, for the respective test log, the synopsis of the respective test log, the probable root cause category for the respective test log, the historical context for the respective test log, and/or the related recurring bug for the respective test log to the report generation subcomponent 430.

In embodiments, the report generation subcomponent 430 creates, in response to the creation of the test report, a defect analysis report. During creation of the defect analysis report, the report generation subcomponent 430 includes the test suite metadata at the beginning of the defect analysis report. The defect analysis report may be generated, for example, in either raw text or JSON format. Other structured or unstructured data formats may also be used. As the report generation subcomponent 430 receives the synopsis of the respective test log, the probable root cause category for the respective test log, the historical context for the respective test log, and/or the related recurring bug for the respective test log, the report generation subcomponent 330 may add a defect analysis log for the respective test log into the defect analysis report.

In embodiments, the defect analysis log for the respective test log includes a defect identifier for the defect associated with the respective test log, source code, the synopsis of the respective test log, the probable root cause category for the respective test log, the historical context for the respective test log, and/or the related recurring bug for the respective test log (which was provided by the context generation subcomponent 420). The defect identifier may be used to uniquely reference each specific defect within the test report. In some embodiments, the defect identifiers are assigned incrementally as defects in the test report are analyzed. Depending on the embodiment, the defect analysis log for the respective test log may include metadata of previously reported issues that might be pertinent to any aspect of the defect associated with the respective test log (e.g., references to previously reported issues).

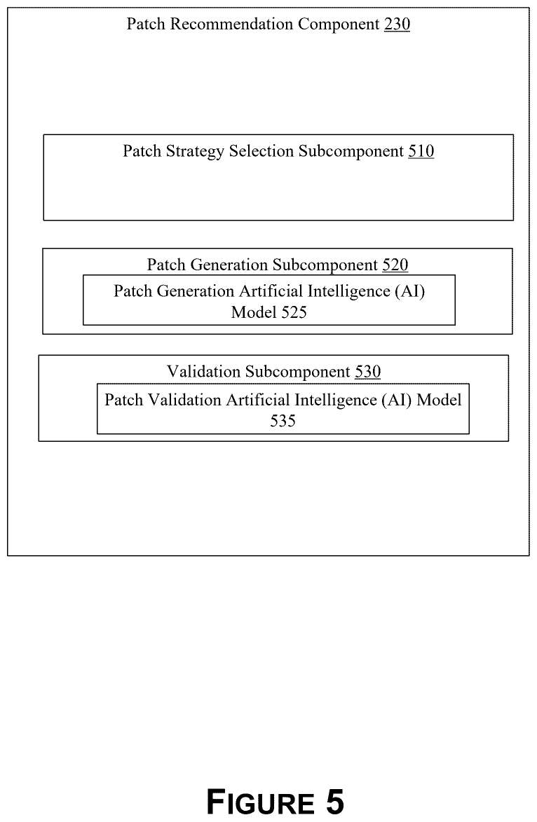

FIG. 5 is an example diagram of the patch recommendation component 230 of FIG. 2, in accordance with one or more aspects of the present disclosure. In one embodiment, the patch recommendation component 230 includes a patch strategy selection subcomponent 510, a patch generation subcomponent 520, and a validation subcomponent 530.

For each defect analysis log in the defect analysis report, the patch strategy selection subcomponent 510 may identify a resolution strategy for a respective defect analysis log using a probable root cause category from the respective defect analysis log. Each probable root cause category has a corresponding resolution strategy in embodiments. The resolution strategy may include a memory safety resolution strategy for the probable root cause category of memory mismanagement, a concurrency resolution strategy for the probable root cause category of concurrency issues, and/or a logic resolution strategy for the probable root cause category of logical errors. The memory safety resolution strategy can include bounds-checking, adjusting pointer lifetimes, and/or switching to safer function calls. The concurrency resolution strategy can include introducing locks, atomic operations, and/or reordering instructions. The logic resolution strategy can include changing conditionals and/or handling of corner cases.

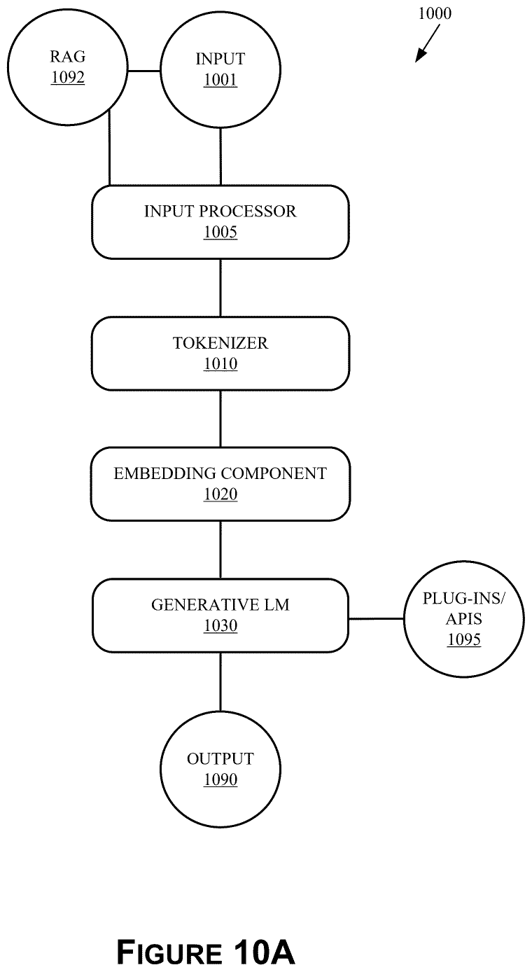

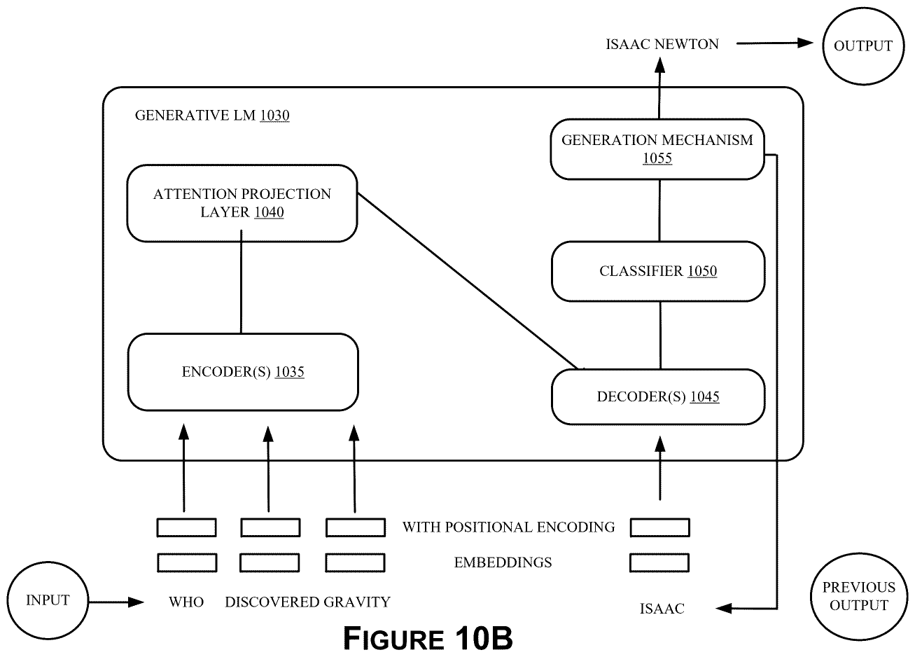

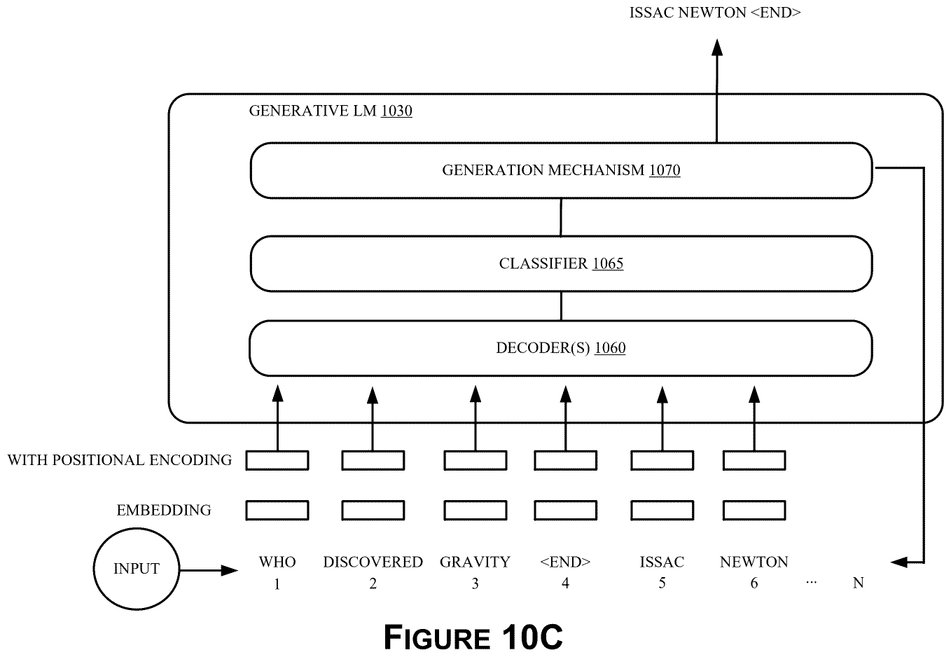

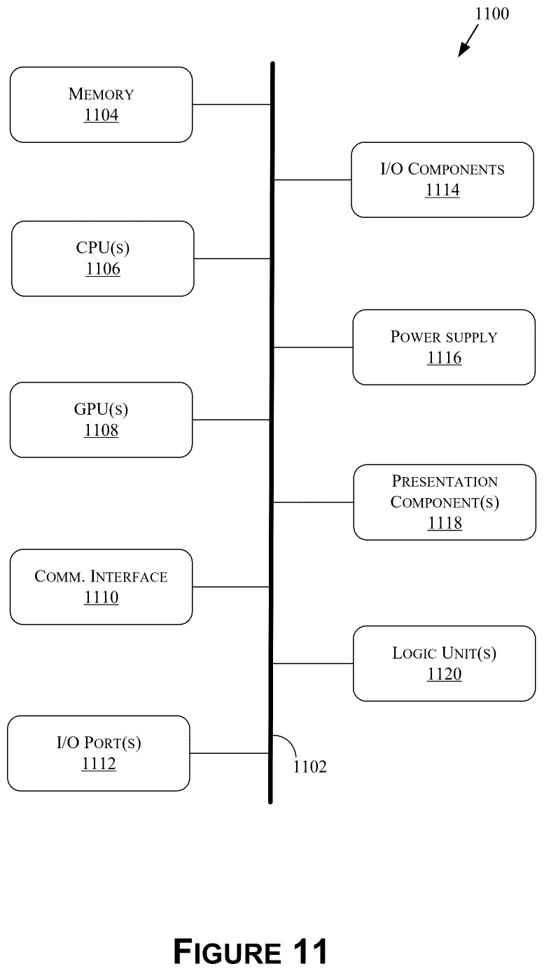

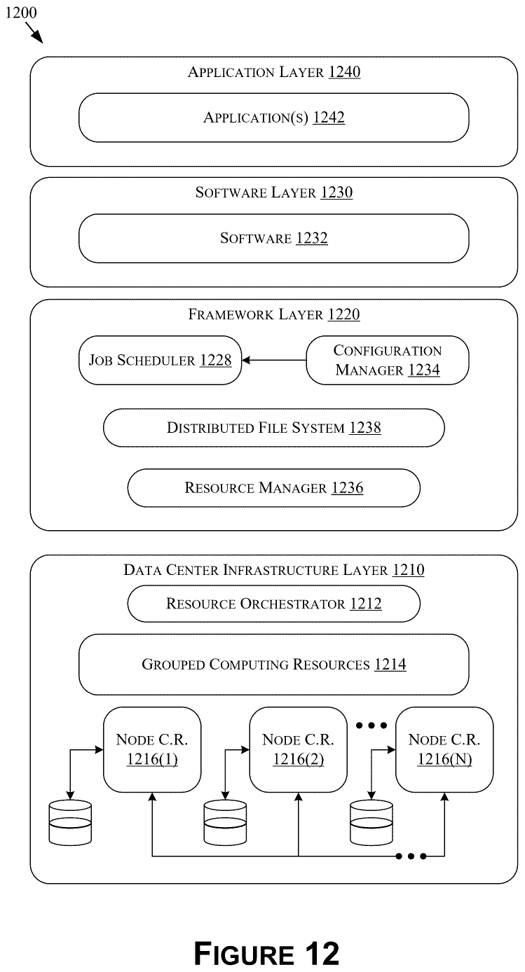

The patch generation subcomponent 520 includes a patch generation artificial intelligence (AI) model 525. The patch generation AI model 525 may be a Large Language Model (LLM) based code generator, to generate source code modifications that can be used to correct defects captured in the defect analysis report. In some embodiments, the patch generation AI model 525 herein may be implemented using one or more generative language models (e.g., as described in FIGS. 10A-10C), one or more computing devices or components thereof (e.g., as described in FIG. 11), and/or one or more data centers or components thereof (e.g., as described in FIG. 12).

In one embodiment, for each defect analysis log of the defect analysis report, the patch generation subcomponent 520 provides a prompt for a respective defect analysis log to the patch generation AI model 525. The prompt for the respective defect analysis log may include the respective defect analysis log and optionally the resolution strategy for the respective defect analysis log.

The patch generation AI model 525 may process the provided input and output one or more recommendations for corrections to the source code (e.g., source code modifications). In some embodiments, the source code modifications for the respective defect analysis log are represented as a code diff for the respective defect analysis log, which shows the differences between two versions of the source code (e.g., between the current version of the source code and a proposed version of the source code). The source code diff typically indicates modifications, additions, and/or deletions in source code. Inserted lines may be marked with “+”, “+a”, or “a+”, while removed lines may be marked with “−”, “−a”, or “a−+”, for example. In some embodiments, the patch generation subcomponent 520 may provide a brief explanation of the purpose of the source code modifications for the respective defect analysis log and/or defect. For example, details on how a particular resolution strategy was implemented to fix the defect associated with the respective defect analysis log may be provided. The patch generation subcomponent 520 may prompt the AI model 525 to create additional test cases for the test suite if needed. For example, the AI model can identify and generate missing test cases required to test a defect and its fix. The subcomponent 520 may also prompt the AI model 525 to modify existing test cases if they don't fully test a defect and its fix. These additional test cases and modifications ensure comprehensive validation and coverage of source code changes.

In embodiments, the validation subcomponent 530 performs preliminary validation on the suggested source code modifications (e.g., the code diff) for the respective defect (e.g., for the respective defect analysis log) to analyze changes for adherence to established coding guidelines, ensure proper integration and test coverage, detect regressions, and/or verify complete implementation without unintentionally disabled code (e.g., avoiding commented-out code). The coding guidelines may include project-specific checklists and/or industry standard practices. In some embodiments, the preliminary validation on the source code modifications (e.g., code diff) for the respective defect analysis log may be performed by the patch generation AI model 525 (in agent-as-judge). In some embodiments, the patch generation AI model 525 outputs, as a response to the prompt, a status of the preliminary validation of the code diff for the respective defect analysis log (e.g., either pass or fail) and details regarding the reasons for the status of the preliminary validation.

In some embodiments, the validation subcomponent 530 may include a patch validation AI model 535 (e.g., which may function in the role of LLM-as-judge) designated to perform preliminary validation on the source code modifications (e.g., code diff) for the respective defect (e.g., defect analysis log) generated by the patch generation AI model 525. The LLM-as-judge (or LLM as judge) is an approach where one or more models (e.g., patch validation AI model 535) are used to evaluate outputs, typically from other models (e.g., patch generation AI model 525). In some embodiments, the patch validation AI model 535 herein may be implemented using one or more generative language models (e.g., as described in FIGS. 10A-10C), one or more computing devices or components thereof (e.g., as described in FIG. 11), and/or one or more data centers or components thereof (e.g., as described in FIG. 12). In embodiments the validation subcomponent 530 provides the prompt to the patch validation AI model 535.

In embodiments, the patch validation AI model 535, similar to the patch generation AI model 525, outputs a status of the preliminary validation and details regarding the reasons for the status of the preliminary validation. Additionally, the output of the patch validation AI model 535 may incorporate additional preliminary validation, such as checking integration, test coverage, and implementation completeness while also conducting quality assessment of approaches, ranking multiple solutions, and verifying compliance against standardized criteria beyond the coding guidelines.

In response to preliminary validation status being unsuccessful (e.g., a fail result), the validation subcomponent 530 may provide another prompt to the patch generation AI model 525 to output further refined source code modifications that can be used to correct the defect according to the details regarding the reasons for the status of the preliminary validation. In response to preliminary validation status being successful (e.g., a pass result), the validation subcomponent 530 may notify the patch application component 240 of the successful preliminary validation.

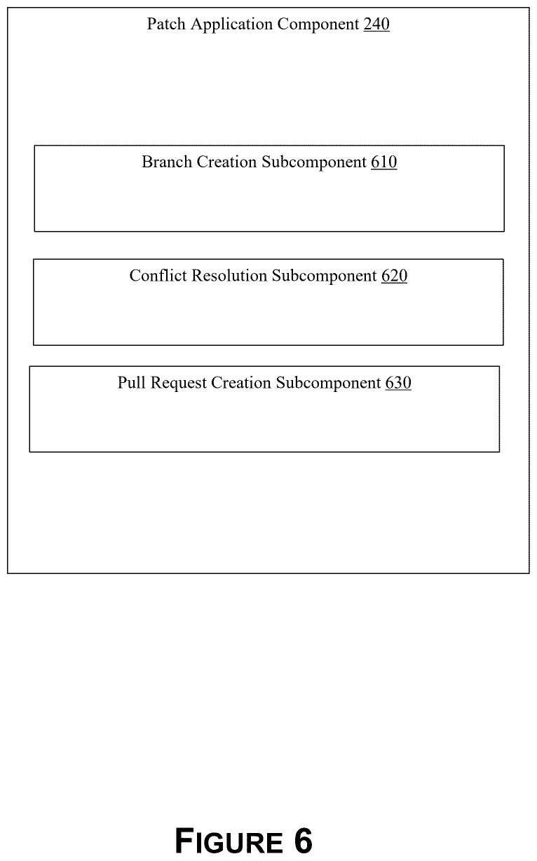

FIG. 6 is an example diagram of the patch application component 240 of FIG. 2, in accordance with one or more aspects of the present disclosure. In embodiments, the patch application component 240 includes a branch creation subcomponent 610, a conflict resolution subcomponent 620, and a pull request creation subcomponent 630.

The branch creation subcomponent 610, in response to the patch component 240 receiving notification of a successful preliminary validation, may create a fix branch in the VC 122. In some embodiments, the fix branch may have a predefined naming convention indicating that the fix branch was created for the defect associated with the respective defect analysis log. For example, “auto-fix-defect-”+defect identifier from the respective defect analysis log+“−” +diagnostic tool identifier from the respective defect analysis log. In embodiments, the branch creation subcomponent 610 applies the source code modifications (e.g., code diff for the respective defect analysis log) to the fix branch by analyzing the differences between files and updating contents of the fix branch accordingly. As previously described, the code diff specifies which lines of code to add, modify, and/or delete in specific files. In embodiments, the branch creation subcomponent 610 processes these instructions sequentially, making the specified changes to the files in the fix branch while preserving any unmodified content.

If a conflict arises between the fix branch and the primary branch, the conflict resolution subcomponent 620 performs resolution of the conflict. Conflict arises if changes in the fix branch overlap with or contradict changes in the primary branch, preventing automatic merging. In embodiments, the conflict resolution subcomponent 620 attempts to resolve the conflict by merging the changes programmatically using predefined reconciliation rules. The predefined reconciliation rules may include accepting the most recent changes, preserving both changes in a specified order, or applying language-specific resolution strategies based on the type of code conflict, for example. If the conflict is not resolved, the conflict resolution subcomponent 620 may flag the conflict for manual intervention.

In embodiments, the pull request creation subcomponent 630, once the code diff for the respective defect analysis log is applied, creates a commit in the VC 122 to establish a permanent snapshot of the changes, making them trackable and revertible if needed. The commit may include a descriptive message with a title summarizing the changes to the source code and/or description detailing the modifications. In some embodiments, the title may have a predefined naming convention. For example, “Auto-fix for “+defect identifier from the respective defect analysis log+“defect”+defect identifier from the respective defect analysis log+“(“+defect type from the respective defect analysis log+“)”. After committing, the pull request creation subcomponent 630 may push these changes to make them accessible in repository 110 managed by the VC 122, enabling other developers to access the changes and creating a backup of the work. The pull request creation subcomponent 630 may then create a pull request or merge request with a title and description reflecting the purpose of the changes, which serves as a formal proposal to integrate the changes into another branch (e.g., a main code branch). The pull request facilitates code review by including references to the original logs and analysis data, enables automated testing, and provides a centralized place for discussion and tracking the status of the proposed changes.

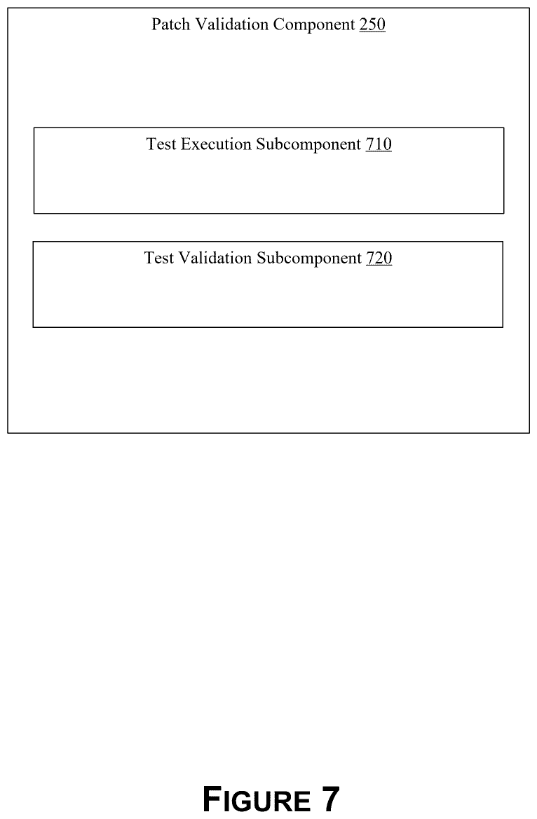

FIG. 7 is an example diagram of the patch validation component 250 of FIG. 2, in accordance with one or more aspects of the present disclosure. In one embodiment, the patch validation component 250 includes a test execution subcomponent 710 and a test validation subcomponent 720.

In some embodiments, prior to a subsequent execution of the test suite, the test execution subcomponent 710 may update the test suite using the additional test cases or modifications to existing test cases generated by the patch generation AI model 525 of the validation subcomponent 530. The test execution subcomponent 710, similar to the test execution subcomponent 310, may enable diagnostic tools and/or source code analysis tools. The test execution subcomponent 710, similar to the test execution subcomponent 310, may execute the test suite in embodiments.

In embodiments, the test validation subcomponent 720, similar to the defect detection subcomponent 320, evaluates execution results, diagnostic tools outputs, and system responses to identify defects for each test case. If no defects are identified for the test suite, test validation subcomponent 720 notifies the patch approval component 260 of the successful validation of the fix branch.

In embodiments, for each defect detected in a respective test case, the test validation subcomponent 720 determines whether a respective defect matches an existing defect in the test report. If the respective defect matches an existing defect in the test report, the test validation subcomponent 720 may include additional contextual information to the contextual information of the existing defect in the test report that matches the respective defect. If the respective defect does not match an existing defect in the test report, the test validation subcomponent 720, similar to the defect detection subcomponent 320 and report generation subcomponent 330, may generate and include a test log into the test report including contextual information of the respective defect (and its corresponding trace log).

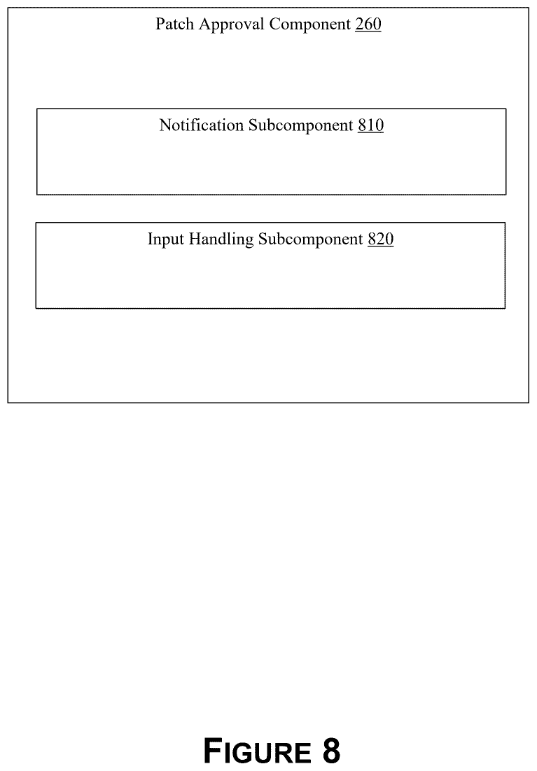

FIG. 8 is an example diagram of the patch approval component 260 of FIG. 2, in accordance with one or more aspects of the present disclosure. In one embodiment, the patch approval component 260 includes a notification subcomponent 810 and an input handling subcomponent 820. In embodiments, the notification subcomponent 810, in response to the patch approval component 260 receiving successful validation of the fix branch, notifies a designated reviewer that the pull request for formal integration of the source code modifications from the fix branch into the primary branch is ready. The input handling subcomponent 820 may receive input from the designated reviewer indicating their decision to approve a new version of code (e.g., a patch), request modifications to the code, or reject the changes to the code. Typically, the designated reviewer's decision may be driven by whether the fix is technically and logically correct and maintainable, and/or whether any additional changes are required.

In embodiments, in response to receiving approval from the designated reviewer, the input handling subcomponent 820 causes the development engine 120 to merge the source code modifications from the fix branch into the primary branch. In some embodiments, the input handling subcomponent 820 may perform (or cause the development engine 120 to perform) staging checks, update documentation, and/or monitor performance for regressions in production. Staging checks validate the changes in a pre-production environment that mirrors production settings to verify system integration and functionality. Documentation updates ensure technical guides, API references, and code comments accurately reflect the implemented changes. Performance monitoring in production tracks system metrics and response times to identify any regressions or unexpected behavior after the changes are deployed.

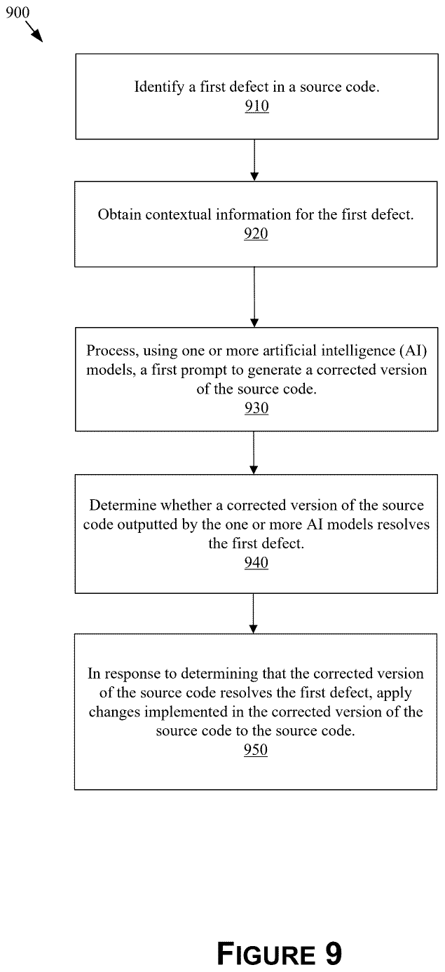

FIG. 9 depicts a flow diagram of an example method 900 for automatic patch generation, in accordance with one or more aspects of the present disclosure. The method may be performed by processing logic that may comprise hardware (circuitry, dedicated logic, etc.), computer readable instructions (run on a general purpose computer system or a dedicated machine), or a combination of both. In an illustrative example, method 900 may be performed by a processor, such as computing device. Alternatively, some or all of method 900 might be performed by another module or machine. It should be noted that blocks depicted in FIG. 9 could be performed simultaneously or in a different order than that depicted. In embodiments, method 900 is performed by SLM system 100 of FIG. 1 and/or defect patch module 135 of FIG. 2.

At block 910 of method 900, the processing logic identifies a first defect in a source code. To identify the first defect in a source code, the processing logic may compile a copy of the source code to generate a first binary. The processing logic may execute a test case on the first binary. In embodiments, the processing logic detects the first defect during execution of the test case on the first binary. In some embodiments, the processing logic detects the first defect during execution of the test case on the first binary by determining that the first binary exhibited one of: a crash, a hang, or anomalous behavior. Depending on the embodiment, the processing logic may perform fuzzing or unit testing, for example, to automatically identify the first defect in the source code.

At block 920, the processing logic obtains contextual information for the first defect. Contextual information may include a diagnostic tool identifier, a test case identifier, a file path, a function name, a line number, a defect type, a stack trace, structural data, log excerpts, reproduction scenarios, and/or diagnostic data. To obtain contextual information for the first defect, the processing logic enables generation of contextual information during execution of a first binary, as described above.

At block 930, the processing logic processes, using one or more artificial intelligence (AI) models, a first prompt to generate a corrected version of the source code. The first prompt may be based at least in part on the source code, the first defect, and the contextual information for the first defect. The one or more AI models may be one or more large language models (LLMs).

At block 940, the processing logic determines whether a corrected version of the source code outputted by the one or more AI models resolves the first defect. To determine whether the corrected version of the source code resolves the first defect, the processing logic may compile a copy of the corrected version of the source code to generate a second binary. The processing logic may enable generation of contextual information during execution of the second binary. The processing logic may execute a test case on the second binary. The processing logic may determine whether a second defect is detected using the same operations described above. In response to determining that no second defect is detected, the processing logic may determine that the corrected version of the source code resolved the first defect.

Depending on the embodiment, responsive to determining that a second defect is detected, the processing logic may identify contextual information associated with the second defect using the techniques described above. The processing logic may process, using the one or more AI models, a second prompt to generate a refined corrected version of the source code. The second prompt may be based in part on the first prompt, the corrected version of the source code, the second defect, and/or the contextual information for the second defect. The processing logic may determine whether the refined corrected version of the source code resolves the second defect. In response to determining that the refined corrected version of the source code resolves the second defect, the processing logic may apply changes implemented in the refined corrected version of the source code to the source code.

At block 950, in response to determining that the corrected version of the source code resolves the first defect, the processing logic applies changes implemented in the corrected version of the source code to the source code. To apply changes implemented in the corrected version of the source code to the source code, the processing logic may identify a difference between the corrected version of the source code and the current version of the source code. The difference represents the changes implemented in the corrected version of the source code. The processing logic may apply the changes implemented in the corrected version of the source code to the source code.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms-may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 10A is a block diagram of an example generative language model system 1000, in accordance with one or more aspects of the present disclosure. In the example illustrated in FIG. 10A, the generative language model system 1000 includes a retrieval augmented generation (RAG) component 1092, an input processor 1005, a tokenizer 1010, an embedding component 1020, plug-ins/APIs 1095, and a generative language model (LM) 1030 (which may include an LLM, a VLM, a multi-modal LM, etc.).

At a high level, the input processor 1005 may receive an input 1001 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1030 (e.g., LLM/VLM/MMLM/etc.). In some embodiments, the input 1001 includes plain text in the form of one or more sentences, paragraphs, and/or documents. Additionally or alternatively, the input 1001 may include numerical sequences, precomputed embeddings (e.g., word or sentence embeddings), and/or structured data (e.g., in tabular formats, JSON, or XML). In some implementations in which the generative LM 1030 is capable of processing multi-modal inputs, the input 1001 may combine text (or may omit text) with image data, audio data, video data, design data, USD data, and/or other types of input data, such as but not limited to those described herein. Taking raw input text as an example, the input processor 1005 may prepare raw input text in various ways. For example, the input processor 1005 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1005 may remove stopwords to reduce noise and focus the generative LM 1030 on more meaningful content. The input processor 1005 may apply text normalization, for example, by converting all characters to lowercase, removing accents, and/or handling special cases like contractions or abbreviations to ensure consistency. These are just a few examples, and other types of input processing may be applied.

In some embodiments, a RAG component 1092 (which may include one or more RAG models, and/or may be performed using the generative LM 1030 itself) may be used to retrieve additional information to be used as part of the input 1001 or prompt. RAG may be used to enhance the input to the LLM/VLM/MMLM/etc. with external knowledge, so that answers to specific questions or queries or requests are more relevant—such as in a case where specific knowledge is required. The RAG component 1092 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1001 may be generated using the query or input to the model (e.g., a question, a request, etc.) in addition to data retrieved using the RAG component 1092. In some embodiments, the input processor 1005 may analyze the input 1001 and communicate with the RAG component 1092 (or the RAG component 1092 may be part of the input processor 1005, in embodiments) in order to identify relevant text and/or other data to provide to the generative LM 1030 as additional context or sources of information from which to identify the response, answer, or output 1090, generally. For example, where the input indicates that the user is interested in a desired tire pressure for a particular make and model of vehicle, the RAG component 1092 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1092 may retrieve a prior stored conversation history—or at least a summary thereof—and include the prior conversation history along with the current ask/request as part of the input 1001 to the generative LM 1030.

The RAG component 1092 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1092 and the embeddings of the chunks along with the embeddings of the query may be compared to identify the most similar/related embeddings to the query, which may be supplied to the generative LM 1030 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1092 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1010 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1030 to understand morphological variations and handle out-of-vocabulary words more effectively. Character-based tokenization represents each character as a separate token, enabling the generative LM 1030 to process text at a fine-grained level. The choice of tokenization strategy may depend on factors such as the language being processed, the task at hand, and/or characteristics of the training dataset. As such, the tokenizer 1010 may convert the (e.g., processed) text into a structured format according to tokenization schema being implemented in the particular embodiment.

The embedding component 1020 may use any known embedding technique to transform discrete tokens into (e.g., dense, continuous vector) representations of semantic meaning. For example, the embedding component 1020 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1001 includes image data/video data/etc., the input processor 1001 may resize the data to a standard size compatible with format of a corresponding input channel and/or may normalize pixel values to a common range (e.g., 0 to 1) to ensure a consistent representation, and the embedding component 1020 may encode the image data using any known technique (e.g., using one or more convolutional neural networks (CNNs) to extract visual features). In some implementations in which the input 1001 includes audio data, the input processor 1001 may resample an audio file to a consistent sampling rate for uniform processing, and the embedding component 1020 may use any known technique to extract and encode audio features—such as in the form of a spectrogram (e.g., a mel-spectrogram). In some implementations in which the input 1001 includes video data, the input processor 1001 may extract frames or apply resizing to extracted frames, and the embedding component 1020 may extract features such as optical flow embeddings or video embeddings and/or may encode temporal information or sequences of frames. In some implementations in which the input 1001 includes multi-modal data, the embedding component 1020 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1030 and/or other components of the generative LM system 1000 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1020 may apply an encoded representation of the input 1001 to the generative LM 1030, and the generative LM 1030 may process the encoded representation of the input 1001 to generate an output 1090, which may include responsive text and/or other types of data.

As described herein, in some embodiments, the generative LM 1030 may be configured to access or use—or capable of accessing or using—plug-ins/APIs 1095 (which may include one or more plug-ins, application programming interfaces (APIs), databases, data stores, repositories, etc.). For example, for certain tasks or operations that the generative LM 1030 is not ideally suited for, the model may have instructions (e.g., as a result of training, and/or based on instructions in a given prompt, such as those retrieved using the RAG component 1092) to access one or more plug-ins/APIs 1095 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1095 to the plug-in/API 1095, the plug-in/API 1095 may process the information and return an answer to the generative LM 1030, and the generative LM 1030 may use the response to generate the output 1090. This process may be repeated—e.g., recursively—for any number of iterations and using any number of plug-ins/APIs 1095 until an output 1090 that addresses each ask/question/request/process/operation/etc. from the input 1001 can be generated. As such, the model(s) may not only rely on its own knowledge from training on a large dataset(s) and/or from data retrieved using the RAG component 1092, but also on the expertise or optimized nature of one or more external resources—such as the plug-ins/APIs 1095.

FIG. 10B is a block diagram of an example implementation in which the generative LM 1030 includes a transformer encoder-decoder. For example, assume input text such as “Who discovered gravity” is tokenized (e.g., by the tokenizer 1010 of FIG. 10A) into tokens such as words, and each token is encoded (e.g., by the embedding component 1020 of FIG. 10A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1035 of the generative LM 1030.

In an example implementation, the encoder(s) 1035 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1040 may convert the context vector into attention vectors (keys and values) for the decoder(s) 1045.

In an example implementation, the decoder(s) 1045 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1035, in an example transformer architecture, each token (e.g., word) flows through a separate path in the decoder(s) 1045. During a first pass, the decoder(s) 1045, a classifier 1050, and a generation mechanism 1055 may generate a first token, and the generation mechanism 1055 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1045 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1035, except that it creates its queries from the layer below it and takes the keys and values (e.g., matrix) from the output of the encoder(s) 1035.

As such, the decoder(s) 1045 may output some decoded (e.g., vector) representation of the input being applied during a particular pass. The classifier 1050 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1055 may select or sample a word or token based on a corresponding predicted probability (e.g., select the word with the highest predicted probability) and append it to the output from a previous pass, generating each word or token sequentially. The generation mechanism 1055 may repeat the process, triggering successive decoder inputs and corresponding predictions until selecting or sampling a symbol or token that represents the end of the response, at which point, the generation mechanism 1055 may output the generated response.

FIG. 10C is a block diagram of an example implementation in which the generative LM 1030 includes a decoder-only transformer architecture. For example, the decoder(s) 1060 of FIG. 10C may operate similarly as the decoder(s) 1045 of FIG. 10B except each of the decoder(s) 1060 of FIG. 10C omits the encoder-decoder self-attention layer (since there is no encoder in this implementation). As such, the decoder(s) 1060 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1060. As with the decoder(s) 1045 of FIG. 10B, each token (e.g., word) may flow through a separate path in the decoder(s) 1060, and the decoder(s) 1060, a classifier 1065, and a generation mechanism 1070 may use auto-regression to sequentially generate one token at a time until predicting a symbol or token that represents the end of the response. The classifier 1065 and the generation mechanism 1070 may operate similarly as the classifier 1050 and the generation mechanism 1055 of FIG. 10B, with the generation mechanism 1070 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). As such, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that allow the computing device 1100 to communicate with other computing devices via an electronic communication network, included wired and/or wireless communications. The communication interface 1110 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may allow the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that allow detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to allow the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1228, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may use distributed file system 1238 for large-scale data processing (e.g., “big data”). In at least one embodiment, job scheduler 1228 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1228. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
identify, using a processing device, a defect in a source code;
obtain contextual information for the defect;
process, using one or more artificial intelligence (AI) models, a prompt to generate a corrected version of the source code, the prompt generated based at least on the source code, the defect, and the contextual information for the defect;
determine whether the corrected version of the source code outputted using the one or more AI models resolves the defect; and
in response to determining that the corrected version of the source code resolves the defect, apply changes implemented in the corrected version of the source code to the source code.

2. The one or more processors of claim 1, wherein the identifying the defect in the source code comprises:
compiling a copy of the source code to generate a binary;
executing a test case on the binary; and
detecting the defect during execution of the test case on the binary.

3. The one or more processors of claim 2, wherein the detecting the defect during execution of the binary comprises:
determining that the binary exhibited one of: a crash, a hang, or an anomalous behavior.

4. The one or more processors of claim 1, wherein the obtaining the contextual information for the defect comprises:
enabling generation of contextual information during execution of a binary, wherein the binary is generated based at least on compiling a copy of the source code;
executing a test case on the binary;
detecting the defect during execution of the binary; and
identifying the contextual information associated with the defect.

5. The one or more processors of claim 1, wherein the determining whether the corrected version of the source code resolves the defect comprises:
compiling a copy of the corrected version of the source code to generate a second binary;
enabling generation of contextual information during execution of the second binary;
executing a test case on the second binary;
determining whether a second defect is detected; and
in response to determining that no second defect is detected, determining that the corrected version of the source code resolved the defect.

6. The one or more processors of claim 5, wherein the one or more processors are to further perform the following responsive to determining that a second defect is detected:
identify contextual information associated with the second defect;
process, using the one or more AI models, a second prompt to generate a refined corrected version of the source code, the second prompt generated based at least on the prompt, the corrected version of the source code, the second defect, and the contextual information for the second defect;
determine whether the refined corrected version of the source code resolves the second defect; and
in response to determining that the refined corrected version of the source code resolves the second defect, apply changes implemented in the refined corrected version of the source code to the source code.

7. The one or more processors of claim 1, wherein the applying the changes implemented in the corrected version of the source code to the source code comprises:
identifying a difference between the corrected version of the source code and the source code, wherein the difference represents the changes implemented in the corrected version of the source code; and
applying the changes implemented in the corrected version of the source code to the source code.

8. The one or more processors of claim 1, wherein the one or more AI models comprise one or more large language models (LLMs), one or more vision language models (VLMs), or one or more multi-modal language models (MMLMs).

9. The one or more processors of claim 1, wherein the one or more processors are to further:
perform at least one of fuzzing or unit testing to automatically identify the defect in the source code.

10. The one or more processors of claim 1, wherein the contextual information comprises at least one of a diagnostic tool identifier, a test case identifier, a file path, a function name, a line number, a defect type, a stack trace, structural data, log excerpts, reproduction scenarios, or diagnostic data.

11. The one or more processors of claim 1, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

12. A system comprising:
one or more processors to:
identify a defect in a source code;
obtain contextual information for the defect;
process, using one or more artificial intelligence (AI) models, a prompt to generate a corrected version of the source code, the prompt generated based at least on the source code, the defect, and the contextual information for the defect;
determine whether a corrected version of the source code outputted by the one or more AI models resolves the defect; and
in response to determining that the corrected version of the source code resolves the defect, apply changes implemented in the corrected version of the source code to the source code.

13. The system of claim 12, wherein to identify the defect in a source code the one or more processors are to:
compile a copy of the source code to generate a binary;
execute a test case on the binary; and
detect the defect during execution of the test case on the binary.

14. The system of claim 13, wherein to detect the defect during execution of the binary the one or more processors are to:
determine that the binary exhibited one of: a crash, a hang, or an anomalous behavior.

15. The system of claim 12, wherein to obtain the contextual information for the defect the one or more processors are to:
enable generation of contextual information during execution of a binary, wherein the binary is generated by compiling a copy of the source code;
execute a test case on the binary;
detect the defect during execution of the binary; and
identify the contextual information associated with the defect.

16. The system of claim 12, wherein to determine whether the corrected version of the source code resolves the defect the one or more processors are to:
compile a copy of the corrected version of the source code to generate a second binary;
enable generation of contextual information during execution of the second binary;
execute a test case on the second binary;
determine whether a second defect is detected; and
in response to determining that no second defect is detected, determine that the corrected version of the source code resolved the defect.

17. The system of claim 16, wherein the one or more processors are further to:
identify contextual information associated with the second defect;
process, using the one or more AI models, a second prompt to generate a refined corrected version of the source code, the second prompt generated based at least on the prompt, the corrected version of the source code, the second defect, and the contextual information for the second defect;
determine whether the refined corrected version of the source code resolves the second defect; and
in response to determining that the refined corrected version of the source code resolves the second defect, apply changes implemented in the refined corrected version of the source code to the source code.

18. The system of claim 12, wherein to applying changes implemented in the corrected version of the source code to the source code the one or more processors are to:
identify a difference between the corrected version of the source code and the source code, wherein the difference represents the changes implemented in the corrected version of the source code; and
apply the changes implemented in the corrected version of the source code to the source code.

19. The system of claim 12, wherein the one or more AI models comprise one or more large language models (LLMs), one or more vision language models (VLMs), or one or more multi-modal language models (MMLMs).

20. The system of claim 12, wherein the one or more processors are further to:
perform at least one of fuzzing or unit testing to automatically identify the defect in the source code.

21. The system of claim 12, wherein the contextual information comprises at least one of a diagnostic tool identifier, a test case identifier, a file path, a function name, a line number, a defect type, a stack trace, structural data, log excerpts, reproduction scenarios, or diagnostic data.

22. The system of claim 12, wherein the system is least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

23. A method comprising:
identifying, using a processing device, a defect in a source code;
obtaining contextual information for the defect;
processing, using one or more artificial intelligence (AI) models, a first prompt to generate a corrected version of the source code, the first prompt generated based at least on the source code, the defect, and the contextual information for the defect;
determining whether a corrected version of the source code outputted by the one or more AI models resolves the defect; and
in response to determining that the corrected version of the source code resolves the defect, applying changes implemented in the corrected version of the source code to the source code.
